(19) United States
(12) Patent Application Publication
(10) Pub. No.: US 2015/0064227 A1
(43) Pub. Date: Mar. 5, 2015

(54) Sporicidal Formulation Including Botanical Extracts/Botanical-Derived Ingredients

(71) Applicants: Douglas Robert Hoffman, Greenville, WI (US); David William Koenig, Menasha, WI (US); Zhe Shi, Shanghai (CN); Yi-Jyun Lin, Shanghai (CN)

(72) Inventors: Douglas Robert Hoffman, Greenville, WI (US); David William Koenig, Menasha, WI (US); Zhe Shi, Shanghai (CN); Yi-Jyun Lin, Shanghai (CN)

(73) Assignee: Kimberly-Clark Worldwide, Inc., Neenah, WI (US)

(21) Appl. No.: 14/345,526

(22) PCT Filed: Oct. 28, 2011
(86) PCT No.: PCT/CN2011/001809

§ 371 Date: Nov. 14, 2014

(51) Int. Cl. A01N 65/22; A01N 25/34; A01N 43/90

(52) U.S. Cl. CPC A01N 65/22; A01N 43/90; A01N 25/34
USPC 424/409; 424/746

(57) ABSTRACT

Formulations and wipes for imparting a sporicide to a surface are disclosed herein. Unexpectedly, a set of naturally derived ingredients have been found to combat and treat spore-based bacteria without the use of harsh chemicals. To achieve the sporicidal efficacy of the product, botanical extracts and/or botanical-derived ingredients have been incorporated into a sporicidal formulation. Example botanical extracts that demonstrated sporicidal activity include: Garcinia morella, Setaria italica, Salvia miltiorrhiza, and Psoralea corylifolia. An example botanical-derived ingredient that demonstrated sporicidal activity included gambogic acid. Unexpectedly, use of these botanicals and/or botanical-derived ingredients on skin provided a sporicidal benefit. Other botanicals and/or botanical extracts were not found to have sporicidal efficacy.

### BACKGROUND

Spores are metabolically dormant microbes that remain viable under a wide range of environmental conditions. Spores are typically heat-, acid-, and desiccation-resistant and can persist in the environment for years. Because of their stability, contamination by spores is very common in hospital, clinical, long-term care or nursing home environments. Often, it can be cultured from almost any surface in a hospital. Patient-to-patient transmission of spores occurs by sharing the medical equipment or facilities in hospitals, nursing homes, and other extended-care facilities. Transmission in community settings also occurs.

Given the pathogenesis of various spore-forming microorganisms, judicious use of antibiotics, strict infection control and environmental measures are keys to the prevention and outbreak of disease. The implementation of antibiotic stewardship programs has been associated with decreased incidence of spore related diseases. To prevent spread of spores, environmental cleaning and patient isolation are needed. Several disinfectants commonly used in hospitals may be ineffective against spores, and may actually promote spore formation.

For example, Clostridium difficile, also known as “CDF/cdf”, or “C. diff.”, a species of gram-positive, spore-forming anaerobic bacillus, can lead to severe complications ranging from antibiotic-associated diarrhea to severe life-threatening pseudomembranous colitis, a severe infection of the colon. In fact, C. diff. is the cause of approximately 25 percent of all cases of antibiotic-associated diarrhea. Most cases of C. diff. associated disease occur in hospitals or long-term care facilities causing more than 300,000 cases per year in the United States alone. The total US hospital costs for C. diff. associated disease management have been estimated to be $3.2 billion per year.

Health care workers should avoid using only alcohol hand sanitizers, especially in outbreak settings, because alcohol is not effective at killing spores. Due to their resistant nature, spores are very difficult to eliminate with standard measures. Consumer and health care applications are taking measures with large amounts of harsh chemicals including ethylene oxide, aldehydes and highly reactive oxidizing agents such as peracetic acid, chlorine dioxide and ozone which are either carcinogenic or corrosive. It would be virtually impossible to use the current technologies/tactics on skin and delicate devices or surfaces. There is a need to develop a sporicide disinfectant that is nonharmful to human skin and the environment but still provides the sporicidal efficacy required by the products necessary to reduce the spore-forming bacteria.

### SUMMARY

Formulations and wipes for imparting a sporicide to a surface are disclosed herein. Unexpectedly, a set of naturally derived ingredients have been found to combat and treat spore-based bacteria without the use of harsh chemicals. To achieve the sporicidal efficacy of the product, naturally derived botanical extracts and/or botanical-derived ingredients have been incorporated into a sporicidal formulation. Example botanical extract that demonstrated sporicidal activity include Garcinia morella, Setaria italica, Eucalypti globulus, Salvia miltiorrhiza, Coptis teeta, and Psoralea corylifolia. Example botanical-derived ingredients that demonstrated sporicidal activity include gambogic acid, neogambogic acid, and cryptotanshinone. Incorporating these botanicals and/or botanical-derived ingredients into products that were then tested and found to provide a sporicidal benefit is an unexpected observation. Other botanicals and/or botanical extracts were not found to have sporicidal efficacy.

Typically, the sporicidal formulation contains botanical extracts or botanical-derived ingredients to provide sporicidal efficacy in an amount from about 0.1 to about 300 mg/ml (by volume of the sporicidal formulation), more typically from about 0.1 to about 250 mg/ml (by volume of the sporicidal formulation), and more typically from about 5 to about 50 mg/ml (by volume of the sporicidal formulation). Desirably, the formulation contains from about 0.1 to about 50 mg/ml (by volume of the sporicidal formulation) of the botanical-derived ingredient. Desirably, the formulation contains from about 50 to about 300 mg/ml (by volume of the sporicidal formulation) of the botanical extract.

In some embodiments, it is beneficial for the sporicidal formulation to also include an antimicrobial agent. The antimicrobial agent may be selected from alcohols, quaternary ammonium compounds, biguanides, phenols, oxidants, alkylating agents, silver, copper, isothiazalones, short-chain acids, or a combination thereof

### DETAILED DESCRIPTION

Generally stated, formulations and wipes for imparting a sporicide to a surface is disclosed herein. Unexpectedly, a set of naturally derived ingredients have been found to combat and treat spore-based bacteria without the use of harsh chemicals. To achieve the sporicidal efficacy of the product, Botanicals and/or botanical-derived ingredients have been incorporated into a sporicidal formulation. Example botanical extracts that demonstrated sporicidal activity include Garcinia morella, Setaria italica, Eucalypti globulus, Salvia miltiorrhiza, Coptis teeta, and Psoralea corylifolia. Example botanical-derived ingredients that demonstrated sporicidal activity include gambogic acid, neogambogic acid, and cryptotanshinone. Incorporating these botanicals and/or botanical-derived ingredients into products that were then tested and found to provide a sporicidal benefit is an unexpected observation. Other botanicals and/or botanical extracts were found to not have sporicidal efficacy.

The sporicidal formulation described herein may be used in combination with a product. More particularly, the sporicidal formulation may be incorporated into or onto a substrate, such as a wipe substrate, an absorbent substrate, a fabric or cloth substrate, or a tissue substrate, among others. For example, the sporicidal formulation may be incorporated into cleansing products, such as wipes, absorbent articles, cloths, and the like. More particularly, the sporicidal formulation may be incorporated into wipes such as wet wipes, dry wipes, hand wipes, face wipes, cosmetic wipes, and the like. In one preferred embodiment, the sporicidal formulation is a liquid composition that may be used in combination with a wipe substrate to form a wet wipe, or may be a wetting composition for use in combination with a dispersible wet wipe.

Reference will now be made in detail to the presently preferred embodiments of the invention. Each example is provided by way of explanation and is not meant as a limitation. For example, features illustrated or described as part of one embodiment can be used on another embodiment or figure to yield yet another embodiment. It is intended that the present disclosure include such modifications and variations.

As described above, the sporicidal formulation requires certain botanical extracts or botanical-derived ingredients to provide sporicidal efficacy. Example botanical extracts that demonstrated sporicidal activity included: Garcinia morella, Setaria italica, Eucalypti globulus, Salvia miltiorrhiza, Coptis teeta, and Psoralea corylifolia. Example botanical-derived ingredients that demonstrated sporicidal activity include gambogic acid, neogambogic acid, and cryptotanshinone. The botanical extracts and botanical-derived ingredients listed above may also be used in combination to provide the sporicidal efficacy.

Typically, the sporicidal formulation contains botanical extracts or botanical-derived ingredients to provide a sporicidal efficacy insoluble oxidant in an amount from about 0.1 to about 300 mg/ml (by volume of the sporicidal formulation), more typically from about 0.1 to about 250 mg/ml (by volume of the sporicidal formulation), and more typically from about 5 to about 50 mg/ml (by volume of the sporicidal formulation). Desirably, the formulation contains from about 0.1 to about 50 mg/ml (by volume of the sporicidal formulation) of the botanical-derived ingredient. Desirably, the formulation contains from about 50 to about 300 mg/ml (by volume of the sporicidal formulation) of the botanical extract.

In some embodiments, it is beneficial for the sporicidal formulation to also include an antimicrobial agent. The antimicrobial agent may be selected from alcohols, quaternary ammonium compounds, biguanides, phenols, oxidants, alkylating agents, silver, copper, isothiazalones, short-chain acids, or a combination thereof.

Typically, the sporicidal formulation may contain an antimicrobial agent in an amount from about 0.01 to about 85 percent (by weight of the sporicidal formulation), more typically from about 0.01 to about 70 percent (by weight of the sporicidal formulation), and more typically from about 0.5 to about 65 percent (by weight of the sporicidal formulation).

The sporicidal formulation exhibits at least a 90 percent reduction of viable spores within about 5 minutes of application of said cleaning medium using the sporicidal efficacy test described herein. Other efficacy tests, including those on skin and hard surfaces, may also be employed to demonstrate at least a 90 percent reduction in viable spores within about 5 minutes.

As noted above, the sporicidal formulation may be incorporated into personal care compositions and wipes to improve the antibacterial benefit of these products. Generally, the wipes including the sporicidal formulation can be wet wipes or dry wipes. As used herein, the term “wet wipe” means a wipe that includes greater than about 70 percent (by weight substrate) moisture content. As used herein, the term “dry wipe” means a wipe that includes less than about 10 percent (by weight substrate) moisture content. Specifically, suitable wipes for use with the sporicidal composition described herein can include wet wipes, dry wipes, hand wipes, face wipes, cosmetic wipes, household wipes, industrial wipes, and the like. Particularly preferred wipes are wet wipes, and other wipe types that include a solution.

Materials suitable for the substrate of the wipes are well known to those skilled in the art, and are typically made from a fibrous sheet material which may be either woven or nonwoven. For example, suitable materials for use in the wipes may include nonwoven fibrous sheet materials which include meltblown, coform, air-laid, bonded-carded web materials, hydroentangled materials, and combinations thereof Such materials can contain synthetic or natural fibers, or a combination thereof Typically, the wipes define a basis weight of from about 25 to about 120 grams per square meter and desirably from about 40 to about 90 grams per square meter.

In one particular embodiment, the wipes may be a coform basesheet of polymer fibers and absorbent fibers having a basis weight of from about 45 to about 80 grams per square meter and desirably about 60 grams per square meter. Such coform basesheets are manufactured generally as described in U.S. Pat. No. 4,100,324, issued to Anderson, et al.; U.S. Pat. No. 5,284,703, issued to Everhart, et al.; and U.S. Pat. No. 5,350,624, issued to Georger, et al., which are incorporated by reference to the extent to which they are consistent herewith. Typically, such coform basesheets contain a gas-formed matrix of thermoplastic polymeric meltblown fibers and cellulosic fibers. Various suitable materials may be used to provide the polymeric meltblown fibers, such as, for example, polypropylene microfibers. Alternatively, the polymeric meltblown fibers may be elastomeric polymer fibers, such as those provided by a polymer resin. For instance, Vistamaxx® elastic olefin copolymer resin designated PLTD-1810, available from ExxonMobil Corporation (Houston, Tex.) or KRATON G-2755, available from Kraton Polymers (Houston, Tex.) may be used to provide stretchable polymeric meltblown fibers for the coform basesheets. Other suitable polymeric materials, or combinations thereof, may alternatively be utilized as known in the art.

The coform basesheet additionally may contain various absorbent cellulosic fibers, such as, for example, wood pulp fibers. Suitable commercially available cellulosic fibers for use in the coform basesheets can include, for example, NF 405, which is a chemically treated bleached southern softwood Kraft pulp, available from Weyerhaeuser Co. (Federal Way, Wash.); NB 416, which is a bleached southern softwood Kraft pulp, available from Weyerhaeuser Co.; CR-0056, which is a fully debonded softwood pulp, available from Bowater, Inc. (Greenville, S.C.); Golden Isles 4822 debonded softwood pulp, available from Koch Cellulose (Brunswick, Ga.); and SULPHATATE HJ, which is a chemically modified hardwood pulp, available from Rayonier, Inc. (Jesup, Ga.).

The relative percentages of the polymeric meltblown fibers and cellulosic fibers in the coform basesheet can vary over a wide range depending upon the desired characteristics of the wipes. For example, the coform basesheet may contain from about 10 to about 90 percent (by weight substrate), desirably from about 20 to about 60 percent (by weight substrate), and more desirably from about 25 to about 35 percent (by weight substrate) of the polymeric meltblown fibers based on the dry weight of the coform basesheet being used to provide the wipes.

In another embodiment, the wipe substrate may be an airlaid nonwoven fabric. The basis weights for airlaid nonwoven fabrics may range from about 20 to about 200 grams per square meter with staple fibers having a denier of about 0.5-10 and a length of about 6 to about 15 millimeters. Wet wipes may generally have a fiber density of about 0.025 to about 0.2 g/cc. Wet wipes may generally have a basis weight of about 20 to about 150 grams per square meter. More desirably the basis weight may be from about 30 to about 90 grams per square meter. Even more desirably the basis weight may be from about 50 to about 75 grams per square meter.

Processes for producing airlaid nonwoven basesheets are described in, for example, published U.S. Pat. App. No. 2006/0008621, herein incorporated by reference.

In an alternative embodiment, the wipes may be a composite which includes multiple layers of materials. For example, the wipes may include a three layer composite which includes an elastomeric film or meltblown layer between two coform layers as described above. In such a configuration, the coform layers may define a basis weight of from about 15 to about 30 grams per square meter and the elastomeric layer may include a film material such as a polyethylene metallocene film. Such composites are manufactured generally as described in U.S. Pat. No. 6,946,413, issued to Lange, et al. (Sep. 20, 2005), which is hereby incorporated by reference to the extent it is consistent herewith.

As mentioned above, one type of wipe suitable for use in combination with the sporicidal formulation is a wet wipe. In addition to the wipe substrate, wet wipes also contain a liquid composition. The liquid composition can be any liquid, which can be absorbed into the wet wipe basesheet and may include any suitable components, which provide the desired wiping properties. For example, the components may include water, emollients, surfactants, fragrances, preservatives, organic or inorganic acids, chelating agents, pH buffers, or combinations thereof, as are well known to those skilled in the art. Further, the liquid may also contain lotions, medicaments, and/or antimicrobials.

The wet wipe composition may desirably be incorporated into the wipe in an add-on amount of from about 10 to about 600 percent (by weight of the treated substrate), more desirably from about 50 to about 500 percent (by weight of the treated substrate), even more desirably from about 100 to about 400 percent (by weight of the treated substrate), and especially more desirably from about 200 to about 300 percent (by weight of the treated substrate).

The desired liquid composition add-on amounts may vary depending on the composition of the wipe substrate. Typically, however, for coform basesheets, the composition add-on amount will be from about 250 to about 350 percent (by weight of the treated substrate), and more typically about 330 percent (by weight of the treated substrate). For air-laid basesheets, the composition add-on amount will typically be from about 200 to about 300 percent (by weight of the treated substrate), and more typically will be about 235 percent (by weight of the treated substrate).

These add-on amounts will preferably result in a wet wipe comprising sporicidal formulation in an add-on amount of from about 1 to about 5 percent (by weight of the treated substrate), and more preferably from about 1.65 to about 4.95 percent (by weight of the treated substrate).

In another embodiment, the wipe is a dry wipe. In this embodiment, the wipe can be wetted with an aqueous solution just prior to, or at the point of, use of the wipe. The aqueous solution can be any aqueous solution known in the art to be suitable for use in wipe products. Generally, the aqueous solution includes mainly water, and can further include additional components, such as cleansers, lotions, preservatives, fragrances, surfactants, emulsifiers, dyes, humectants, emollients, oils, sunscreens, and combinations thereof. The sporicidal formulation may be present in the aqueous solution used to wet the dry wipe prior to use.

Alternately, the dry wipe may be prepared by applying by any suitable means (e.g., spraying, impregnating, etc.) a composition comprising a sporicidal formulation described herein onto a wipe substrate. The composition may contain 100 percent of the sporicidal formulation, or alternately, the sporicidal formulation may be present in the composition in combination with a carrier and/or other skin benefit agent, as described herein. In embodiments where the sporicidal formulation used to prepare the dry wipe contains water or moisture, the resulting treated substrate is then dried so that the wipe contains less than about 10 percent (by weight substrate) moisture content, and a dry wipe is produced. The treated substrate can be dried by any means known to those skilled in the art including, for example by use of convection ovens, radiant heat sources, microwave ovens, forced air ovens, and heated rollers or cans, or combinations thereof.

The dry wipe may contain the sporicidal formulation in an add-on amount composition of from about 40 to about 250 percent (by weight of the treated substrate), more desirably about 100 percent (by weight of the treated substrate). One may use a wipe sheet to clean various different kinds of surfaces either in a clinical or other type of setting. These may include, for instance, various desk, table or countertops or other parts of furniture surfaces, bath and lavatory surfaces, floor and wall surfaces, medical instruments or devices, bedding and linens or even human skin. In a liquid form, the sporicidal formulation may be employed in bath or rinse to wash medical instruments, linens, bedclothes, or human skin. One may even incorporate use the formulation in a disinfecting or sanitary solution to wash hands or medical instruments.

### Test Method

### Sporicidal Efficacy Test

Objective:

To determine the kill rate of solutions of interest against bacterial spores.

Materials:
1. Test solutions of interest
2. Clostridium difficile ATCC 43593
3. Geobacillus stearothermophilus CICC 10142
4. Filter sterilized MilliQ water
5. Neutralization broth (prepared according to directions below)
6. Brain Heart Infusion (BHI) agar plates with 0.15% Sodium Taurocholate
7. Tryptic Soy Agar (TSA) plates
8. Taurocholic acid sodium salt hydrate (Sigma-Aldrich T-4009)
9. Phosphate buffered saline (PBS) pH 7.2
10. Fetal Bovine Serum (FBS)
11. Sterile plating beads
12. Sterile Eppendorf vials (1.5 mL)
13. Sterile tubes (15 mL)
14. Pipettes and sterile pipette tips (100 μL and 1000 μL)
15. Incubator capable of 37±3° C.
16. Anaerobic rectangular jar (7 Liter AnaeroPack System commercially available from Mitsubishi Gas Chemical Co.) with 3 GasPak satchels (BD GasPak EZ, #260678)

Procedure:
1. Prepare culture stock of organism of interest to 10⁷ CFU/ml in PBS.
2. Thoroughly vortex the stock culture for ten minutes at medium-high speed.
3. Dilute a small portion of the stock culture in MilliQ filter sterilized water and add FBS soil load to the inoculum to achieve a concentration of 5% v/v FBS.
4. Place the inoculum in a sonicating water bath for five cycles of one minute on, one minute off
5. Add 100 μL of spore culture to sterile vial containing 900 μL of test solution and vortex.
6. After the test exposure time, vortex the vials.
7. Transfer 100 μL of test solution and spore mixture to sterile tubes containing 900 μL neutralization broth to neutralize.
8. Place the neutralized samples in a sonicating water bath for five cycles of one minute on, one minute off
9. Vortex each tube. For C. difficile, pipette 100 μL of each neutralized sample on BHI+0.15% sodium taurocholate media plates (prepared in lab according to dehydrated powder instructions). For G. stearothermophilus, pipette 100 μL of each neutralized sample onto TSA plates. Spread using sterile beads.
10. Prepare a control sample by adding the spore culture to 900 μL of filter sterilized MQ water and repeat steps 3-6 above. Dilute control code to achieve 10² CFU/ml.
11. For C. difficile, place plates in anaerobic jars or boxes (with appropriate number of catalase pouches) or in the anaerobic chamber and incubate for 48±8 hours at 37±3° C. For G. stearothermophilus, incubate plates aerobically for 48±8 hours at 37±3° C.
12. After incubation, enumerate colonies and record results. Calculate Log₁₀ reduction by comparing the number of colonies recovered from the test solution versus those recovered with the control.

Neutralization Broth Preparation:
1. Mix the following ingredients:
   1 L Letheen broth
   0.3% ppm Lecithin
   3% ppm Tween 80
   0.1% ppm Histidine
2. Solution is sterilized by autoclave.
3. Catalase (0.1-0.2%) is added when completely cooled and then filter sterilized.

### EXAMPLES

### Example 1

In this example, sporicidal formulations were prepared by placing botanical extracts in a solution of 75 percent by volume of ethanol and 25 percent by volume of water. The following botanical extracts were shown to provide sporicidal efficacy.

TABLE 1
Sporicidal activity of botanical extracts against C. diff. spores.

| | | Log Reduction |
|---|---|---|
| Botanical Extract | Concentration | (5 min contact time) |
| Setaria italica | 100 mg/ml | 2.08 |
| Garcinia morella | 200 mg/ml | 4.14 |
| Eucalypti globulus | 200 mg/ml | 3.25 |
| Salvia miltiorrhiza | 100 mg/ml | 1.63 |
| Psoralea corylifolia | 100 mg/ml | 1.03 |
| Coptis teeta | 100 mg/ml | 1.85 |

### Example 2

In this example, sporicidal formulations were prepared by placing botanical-derived ingredients in a solution of 75 percent by volume of ethanol and 25 percent by volume of water. The following botanical-derived ingredients were shown to provide sporicidal efficacy.

TABLE 2
Sporicidal activity of botanical-derived
ingredients against C. diff. spores

| Botanical | | Log Reduction |
|---|---|---|
| Extract | Concentration | (5 min contact time) |
| Neogambogic | 10 mg/ml | 3.96 |
| acid | | |
| Gambogic acid | 10 mg/ml | 3.96 |
| Cryptotanshinone | 5.9 mg/ml | 3.43 |

### Example 3

### Comparative

The following botanical extracts were tested to determine the sporicidal activity: osthole, usnic acid, kaempferol, genistein, luteolin, protopine, noroxylin, salidroside, quercetin, puerarin, p-hydroxy-cinnamic acid, Artemisia argyi levl. et vant., Smilax china l., Ginkgo biloba l., Gletilla striata (thunb.) reichb.f, Ajuga decumbens thunb., Chelidonium majus l., Paeonia lactiflora pall., Atractylodes macrocephala koidz., Litsea cubeba (lour.) pers, Alpinia officinarum hance, Schizonepeta tenuifolia brig., Portulaca oleracea l., Elsholtzia splendens nakai ex f.maekawa, Scrophularia ningpoensis hemsl., Anemarrhena asphodeloides bunge, Cirsium japonicum dc., Stephania cepharantha, Angelica dahurica (fisch. ex hoffin.) benth. et hook. f, Stemona japonica (bl).miq., Stemona sessilifolia (miq.) miq., Lobelia chnensis lour., Macleaya cordata (willd.) r.br., Amomum tsao-ko crevost et lemaire, Camellia sinensis kuntze, Plantago asiatica l., Paeonia veitchii lynch, Andrographis paniculata (burm.f.) nees., Acanthopanax senticosus (rupr.et maxim.) harms, Rheum palmatum l., Codonopsis tubulosa kom, Juncus effusus l., Kochia scoparia (l.) schrad., Sanguisorba officinalis l., Curcuma phaeocaulis val, Curcuma kwangsiensis S. G. Lee et C. F. Liang, Pueraria iobata (willd.) ohwi, Pogostemon cablin (blanco) benth., Cinnamomum cassia presl., Polygonum flaccidum meissn., Polygonum cuspidatum sieb. et zucc., Scutellaria baicalensis georgi, aloe vera l., Ephedra sinica stapf, Ephedra intermedia schrenk et C. A. Mey., Ephedra equisetina bge., Lasiosphaera fenzlii reich., Vitex trifolia l., Belamcanda chinensis (l.), Evodia rutaecarpa (juss.) benth., Cyperus rotundas l., Cynanchum paniculatum (bunge) kitag, Inula japonica thunb., Inula Britannica l., Daemonorops draco bl., Thalictrum baicalense turcz., Baphicacanthus cusia (nees) brem. Litsea cubeba (lour.) pers, Berberis vernae schneid. None of these botanical extracts illustrated sporicidal activity under the Sporicidal Efficacy Test described herein.

The following ingredients derived from botanical extracts were also tested: tanshinone IIA, dihydrotanshinone, L-alanine, β-alanine, L-proline, isoquercetrin, isoquercitrin, ferulic acid, caffeic acid, hyperoside, cineole, protocatechuic acid, p-hydroxybenzoic acid, stigmasterol, neobavaisoflavone, oleanolic acid, isoimperatorin, imperatonin, geniposide, bavachin, bavachinin, icaritin. None of these ingredients derived from botanical extracts illustrated sporicidal activity under the Sporicidal Efficacy Test described herein.

Unexpectedly, as illustrated by the large number of botanicals and botanical-derived ingredients that did not show sporicidal efficacy, the botanical extracts and botanical-derived ingredients described herein illustrate sporicidal efficacy. Furthermore, botanical-derived ingredients very similar in structure did not perform similarly. For example, cryptotanshinone was found to have sporicidal activity against C. diff. while tanshinone IIA and dihydrotanshinone were found to have no detectable effect. These compounds are very similar in structure; for example cryptotanshinone differs in structure from tanshinone IIA only by having two less hydrogen atoms on its pentyl ring. It would be expected that such similar structured chemicals would have a similar effect, but only certain botanical extracts and botanically derived ingredients functioned against spores.

Other modifications and variations to the appended claims may be practiced by those of ordinary skill in the art, without departing from the spirit and scope as set forth in the appended claims. It is understood that features of the various examples may be interchanged in whole or in part. The preceding description, given by way of example in order to enable one of ordinary skill in the art to practice the claimed invention, is not to be construed as limiting the scope of the invention, which is defined by the claims and all equivalents thereto.

1. A sporicidal formulation comprising:
botanical extracts/botanical-derived ingredients selected from Garcinia morella, Setaria italica, Salvia miltiorrhiza, Coptis teeta, Psoralea corylifolia, neogambogic acid, and combinations thereof.

2. The sporicidal formulation of claim 1 wherein the formulation comprises from about 0.1 to about 300 mg/ml of the botanical extract or botanical-derived ingredient.

3. The sporicidal formulation of claim 1 further comprising a solvent.

4. The sporicidal formulation of claim 3 wherein the solvent is ethanol, isopropanol, water, and combinations thereof.

5. The sporicidal formulation of claim 1 further comprising an antimicrobial agent.

6. The sporicidal formulation of claim 5 wherein the antimicrobial agent is selected from alcohols, quaternary ammonium compounds, biguanides, phenols, oxidants, alkylating agents, silver, copper, isothiazalones, short-chain acids, or a combination thereof.

7. The sporicidal formulation of claim 1 wherein the formulation comprises from about 0.1 to about 50 mg/ml of the botanical-derived ingredient.

8. The sporicidal formulation of claim 1 wherein the formulation comprises from about 50 to about 300 mg/ml of the botanical extract.

9. A wipe comprising:
a wipe substrate; and
a sporicidal formulation comprising botanical extracts/botanical-derived ingredients selected from Garcinia morella, Setaria italica, Salvia miltiorrhiza, and Psoralea corylifolia, neogambogic acid, and combinations thereof.

10. The wipe of claim 9 wherein the formulation comprises from about 0.1 to about 300 mg/ml of the botanical extract or botanical-derived ingredient.

11. The wipe of claim 9 further comprising a solvent.

12. The wipe of claim 11 wherein the solvent is selected from ethanol or isopropanol water and combinations thereof.

13. The wipe of claim 9 further comprising an antimicrobial agent.

14. The sporicidal formulation of claim 5 wherein the antimicrobial agent is selected from alcohols, quaternary ammonium compounds, biguanides, phenols, oxidants, alkylating agents, silver, copper, isothiazalones, short-chain acids, or a combination thereof.

15. The wipe of claim 9 wherein the formulation comprises from about 0.1 to about 50 mg/ml of the botanical-derived ingredient.

16. The wipe of claim 9 wherein the formulation comprises from about 50 to about 300 mg/ml of the botanical extract.
